(19) United States
(12) Patent Application Publication
(10) Pub. No.: US 2021/0302078 A1
(43) Pub. Date: Sep. 30, 2021

(54) METHOD AND SYSTEM FOR IMPULSE AND CYCLIC TRANSFER OF HEAT THROUGH A HEAT-TRANSFERRING WALL

(71) Applicants: Lev GOLDSHTEIN, Pardes Hanna-Karkur (IL); Yakov ELGART, Melbourne (AU)

(72) Inventors: Lev GOLDSHTEIN, Pardes Hanna-Karkur (IL); Yakov ELGART, Melbourne (AU)

(21) Appl. No.: 17/264,347

(22) PCT Filed: Jul. 30, 2019
(86) PCT No.: PCT/IL2019/050859

§ 371 Date: Jan. 29, 2021

(30) Foreign Application Priority Data
Aug. 1, 2018 (AU) 2018902805

(51) Int. Cl. F25B 41/22; F25B 1/00; F25B 41/345; F25B 41/40

(52) U.S. Cl. CPC F25B 41/22; F25B 1/005; F25B 39/02; F25B 41/40; F25B 2700/2103; F25B 41/347

(57) ABSTRACT

The invention is an impulse system and a method for heat transfer in thermal nonequilibrium state through a heat-transferring wall of a heat transferring volume. The system is based on a heat transferring volume and an impulse device in fluid, pressure and thermal communication with each other, where the impulse device delivers a heat load to the heat transferring volume through a working medium in condensed phase impulses. The impulse device controls the rate of delivery of impulses such that each subsequent impulse is received before the heat capacity of the heat transferring wall returns to an equilibrium state thereby resulting in an accumulation of the changes in heat capacity of the heat transferring wall and subsequent changes in the temperature of the heat-transferring wall above or below the wall thermal equilibrium state to increase the heat transfer flow through the wall.

### FIELD OF INVENTION

The present invention relates generally to the use of impulses and the cyclic transfer of heat through heat-transferring walls made from, for example, metal alloys. In particular, the present invention relates generally to the application of impulses and cyclic transfer of heat through heat-transferring walls in heat receivers, evaporators, condensers, etc. of thermal equipment and other systems that use thermal energy.

### BACKGROUND OF THE INVENTION

In thermodynamic systems, there have been a number of different types of thermal equipment proposed that employ an impulse functioning method to operate. Such systems are disclosed in U.S. Pat. No. 4,631,926; German Patent No DE 23242; Danish Patent No. 3755/85; Japanese Patent No. 66159/1987 and International Patent Application PCT/IL2016/051269. Each of the above referenced patents discloses thermal equipment that uses an impulse functioning method. However, such systems fail to consider the principle of impact of the impulse method on the walls of the heat exchange system, such systems including evaporators-heat receivers, condensers, and the like. Based on the analysis of the above systems, it would seem that, in accordance with the classic laws of thermodynamics, the isothermal external heat flow absorbed by a solid body during a continuous heat flow effect, results in the solid body's temperature approaching the temperature of the heat flow in an asymptotical manner. However, in the case where the system employs an impulse and/or cyclic heat flows, there are some contradictions, which in practical use do not correspond to the existing information based on continuous effect systems.

In this regard, most existing knowledge is based on an assumption that the thermophysical characteristics of all bodies participating in heat transfer are constant at a certain moment of time. However, this presumption does not always reflect the reality. For example, in practice, the temperature of a heat-transferring wall is not a constant value. In metals (metal alloys), thermal processes are mainly determined only by the intensity of movement of the electrons, which form the Fermi gas. However, in actual fact the energy processes of metals are much more multifaceted, and need to consider a number of variables, such as changes in temperature and velocity. Moreover, a phenomenon that takes place in solid bodies, in particular, changes in heat capacity on an impulse front, are typically not taken into account.

Thus, in taking into consideration all of the variables, which in reality affect the course of thermal processes during the use of impulse cyclic heat flows, the resulting changes in both flow and wall temperature of the system require considerable consideration. This leads to a marked difference between theoretical and experimental results. Conventional systems may mention impulse methods of heat transfer in refrigeration systems. However, the process of heat transfer through a wall in heat exchangers (evaporators) has not been discussed or considered in any detail when modelling such systems. Such a new impulse method of heat transfer enables more effective use of heat exchange systems in newly designed thermal equipment and significantly improves such systems which are currently in use.

The experimentally observed phenomenon of overcooling or overheating in solid bodies, (metal alloys), in case of impulse (cyclic) impact of heat flows provides a new possibility for heat exchange through a solid wall and does not contradict the law of conservation of energy. Thus, there is a need to provide for a heat transfer system having an increased heat transfer through a wall in solid bodies, for example, in metal alloys, in case of impulse impact by heat flow. Such a system is able to provide increased efficiency of thermal equipment, for example, in refrigeration systems and offers a reduction of size and weight of heat exchange equipment and provides for an increase in the Coefficient of Performance (COP) of thermal equipment. The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims. Accordingly, in one aspect of the invention there is provided a method for heat transfer through a heat-transferring wall, comprising: delivering a heat load to the heat transferring wall in impulses; and controlling the rate of delivery of said impulses such that each subsequent impulse is received before the heat capacity of the heat transferring wall returns to an equilibrium state thereby resulting in an accumulation of the changes in heat capacity of said heat transferring wall and subsequent changes in the temperature of the heat-transferring wall above or below the said equilibrium state to increase the heat transfer flow through the wall.

The step of delivering the heat load to the heat-transferring wall may comprise controlling a frequency of the impulses such that any incremental increases in the heat load will result in the frequency of impulses increasing. The step of delivering the heat load to the heat-transferring wall comprises controlling a frequency of the impulses such that any incremental decreases in the heat load will result in the frequency of impulses decreasing. The heat-transferring wall may be made from a metal alloy. Pressure intervals between the impulses may vary within 0.01÷0.04 MPa (0.1÷0.4 bar).

In another aspect of the invention, there is provided a heat transfer system for performing the method of the first aspect of the invention comprising, for example, a heat receiver (evaporator), compressor, condenser, heat exchanger, and impulse device placed in close proximity to the heat receiver (evaporator).

The system may further comprise a device regulating a supply of pressure and corresponding temperature based impulses to the heat receiver (evaporator), wherein the device comprises a solenoid valve and a two-position pressure relay.

The device may comprise the solenoid valve and a two-position pressure relay together into a single device or they may be provided separately.

A range of the impulse device may exceed a selected pressure at switching on and can, for example, be ΔP₁=0.1÷0.4 bar, and at switching off can be below the selected pressure (and correspondingly the boiling temperature), and equals, for example, ΔP₂=0.1÷0.4 bar, with average pressure in heat receiver (evaporator) corresponding to the previously selected pressure, and correspondingly the temperature, based on technological parameters. The impulse device which switches on the two-position pressure relay may be connected to a vapour chamber in heat receiver using an impulse pipe.

### BRIEF DESCRIPTION OF THE DRAWINGS

The invention may be better understood from the following non-limiting description of preferred embodiments, in which:

FIG. 1 is a schematic diagram of a set-up based on the impulse method of supplying of a working medium in accordance with an embodiment of the present invention; and

FIG. 2 shows a comparative diagram of refrigerating cycle, based on the impulse method of supply of a working medium of FIG. 1.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

As will be described in more detail below, the present invention relates specifically to the impulse and cyclic methods of heat transfer through a metal wall and an example of a set-up for its utilisation. It is understood that at certain rates of heating and cooling of a heat-transferring wall the temperature becomes lower (in case of cooling), and higher (in case of heating), than the temperature of the working medium. This difference may be by approximately 15% or more.

However, correctly conducted experiments using a laboratory set-up revealed some contradictions that do not fit the framework of traditional theories for heat transfer and heat-mass exchange.

The phenomenon of an increase or decrease in temperature in the case of impulse (periodical) impact of heat flows on solid bodies (metal alloys) can increase the overall efficiency of heat receivers, evaporators, condensers, heat exchangers, and other heat exchange systems of thermal equipment, as well as reduce the required amount of metal, mass, required in such systems and increase their efficiency. Thus, in the case of impulse (cyclic) impact of heat flow provides a new possibility for heat exchange through a solid wall which does not contradict the law of conservation of energy. In addition to these advantages associated with understanding of the impulse (periodical) impact of heat flows on solid bodies, it is also important to note the improvement of energy saving technologies, cooling and heating, as well as an increase in efficiency of transformation of heat, in particular, into electricity. In accordance with an embodiment of the present invention, it will be appreciated that in situations involving impulse and cyclic impact of heat on a metal heat-transferring wall, for example, a wall made from metal alloys, each subsequent impulse starts before the heat capacity in the wall returns to equilibrium (relaxation). This then results in an accumulation of changes in heat capacity that leads to changes in the temperature of the wall that are above or below the equilibrium point, in which case the transfer of heat flow through the heat-transferring wall increases. Thus, with an increase of load, the frequency of the impulses increases, and with a reduction of the load, the frequency of the impulses decreases.

In view of the above, in one aspect, the present invention provides an impulse heat exchange system comprising:

a heat transferring volume; and
an impulse device,
where the impulse device is in thermal, pressure and fluid communication with the heat transferring volume, where the impulse device is configured to receive a working medium in condensed phase and introduce the working medium into the heat transferring volume in an impulse regimen of heat flow.

Further, the impulse device comprises a device for regulating supply of the working medium to the heat transferring volume in the impulse regimen of heat flow, where the impulse regimen of heat flow maintains non-equilibrium heat capacity of the walls of the heat transferring volume.

Accordingly, the present invention provides a heat exchange system which is capable of heat exchange according to the following regimen:

setting average pressure and corresponding boiling temperature values of the working medium in the heat transferring volume;
setting pressure value of the working medium in the impulse device at a predetermined difference from the average pressure in the heat transferring volume; and
introducing selected amounts of the working medium at selected frequency from the impulse device into the heat transferring volume.

The selected amounts and frequency are set to maintain the non-equilibrium heat capacity of the walls of the heat transferring volume, where the walls are maintained at thermal non-equilibrium state upon transfer of heat load from the working medium through the walls to surroundings of the walls.

Correspondingly with the heat exchange system, the present invention also provides a method for impulse heat exchange, where such method comprises:

providing a heat transferring volume and an impulse device in thermal, pressure and fluid communication with the heat transferring volume;
setting average pressure and corresponding boiling temperature values of a working medium in the heat transferring volume;
setting pressure value of the working medium in the impulse device at a predetermined difference from the average pressure in the heat transferring volume; and
introducing selected amounts of the working medium in condensed phase at selected frequency from the impulse device into the heat transferring volume in an impulse regimen of heat flow; and
maintaining non-equilibrium heat capacity of walls of the heat transferring volume upon transfer of heat load from the working medium through the walls to surroundings of the walls.

Further, this method comprises providing a device for regulating supply of the working medium in the impulse device; and

controlling frequency of impulses and increasing the frequency upon incremental increase in the heat load and decreasing the frequency upon incremental decrease in the heat load upon introduction of the working medium from the impulse device into the heat transfer volume.

In another embodiment of the method of the present invention the pressure value in the impulse device is higher than the average pressure value in the heat transferring volume by a predetermined difference upon impulse of the working medium into the heat transferring medium and lower than the predetermined difference between consecutive impulses of the working medium.

In one embodiment of the present invention, a heat-transferring volume is provided (for example, a heat receiver or evaporator) and is filled by impulses (in individual portions) with a liquid working medium, for example, a cooling agent. In such an environment, the temperature and the corresponding pressure obtained from the boiling (evaporating) volume in the heat receiver or evaporator are set in advance. The intervals between impulses (switching on and off) are set in accordance with average pressure, for example, 0.01÷0.04 MPa (0.1÷0.4 bar) and average temperature of the working medium, which are set in advance in a heat receiver or evaporator.

To supply and generate the impulses of liquid working medium in the thermal equipment, for example, a refrigeration system, a heat receiver (evaporator) is typically equipped with an impulse device, which is located in the immediate proximity to the heat receiver.

This impulse system can consist of a device that initiates and regulates impulses, based on the pressure or the temperature in the heat receiver or evaporator. In one embodiment, the device may include a solenoid valve and a two-position pressure relay, which can be integrated into one unit or presented as separate units. The pressure present in the impulse device may be set in advance based on technological requirements of the system, but should be set to exceed the average pressure (and the corresponding boiling temperature) in an evaporator. By way of an example, the pressure present in the impulse device may be set to exceed the average pressure by 0.1÷0.4 bar (0.01÷0.04 MPa) when the device is switched on. When the device is switched off, the pressure should be retained below a preselected average pressure (and the corresponding boiling temperature, for example, by 0.1÷0.4 bar (0.01÷0.04 MPa). The impulse device that switches on the two-position pressure relay is connected to a vapour chamber of the heat receiver, for example, using an impulse pipe.

By applying analytical research methods of non-equilibrium states that involve boundary conditions of the third kind, i.e. the conditions of proportionality of heat flow near the wall q(x, τ) to difference in temperature of heat flow (Tw−T₀₀), which requires a coefficient of proportionality α (x₂ τ), also known as a coefficient of heat transfer, (the Newton Law), it is possible to also determine:

i) The rate of heat distribution within the material—inner problem (intensity of heating or cooling);
ii) The rate of heat distribution from outside medium towards the solid surface (outer problem); and
iii) The rate of heat transfer through the boundary layer (boundary-value problem).

However, in conditions where the temperature of a solid body and the temperature of a heat flow changes constantly, the use of a ratio for boundary conditions of the following type: q=α(Tw−T₀₀)=Nu λ/l(Tw−T₀₀), does not properly apply and can lead to erroneous results. This was confirmed by the present applicants through practical experiments. Thus, there is a need to revise analytical solutions of differential equations in relation to impulse heat flows, which cannot be resolved using the classical concepts described in technical and scientific literature on thermodynamics and heat-mass transfer. Fundamental principles of these works state that thermal physical characteristics are constant and depend on coordinates and time. However, this does not correspond with real processes, for example the temperature of a wall is not constant. Hence, for the thermal processes in metal, these are mainly determined only by intensity of movement of electrons that form the Fermi gas. In real life, energy processes are much more multifaceted, and require consideration of a variety of other variables, for example, changes in velocity and temperature. However, conventional approaches have given no consideration for phenomena that take place in a solid body, in particular, changes in internal energy at the impulse front. The present applicants determined through experimental data the increase or decrease in temperature of metal alloys in case of impulse impact of external heat flow. Conditions of heat exchange for impulse impact of heat flow and change in heat capacity can be described as follows:

To the equation of the classical thermodynamics:

$$C v = \frac{( d u )}{( d T )} \qquad ( 2 )$$

However, it is necessary to add the ability of the heat capacity to change, depending not only on temperature but also on a rate of intrinsic change, i.e.

$$d C v = d \frac{( \partial U )}{( \partial T )} + d ( \frac{( \partial {C}_{v} )}{( \partial T )} \times \frac{( \partial T )}{( \partial τ )} ) \qquad ( 3 )$$

With impulse (or cyclic) impact every subsequent cycle starts before the heat capacity returns to equilibrium. This leads to an accumulation of changes in the heat capacity which results in maintaining the temperature above or below equilibrium and increases of heat flow transfer through a heat transferring wall.

In instances of impulse cooling or heating with a frequency less than required for obtaining equilibrium of heat capacity, the overcooling or overheating of the system reaches significant values and is maintained for the entire period of cyclic heating or cooling. Experimental data confirms the increase or decrease in temperature, in case of impulse impact by external heat flow on a metal alloy wall, for example, a wall made from stainless steel or aluminium-magnesium alloy.

In general, the pressure value in the impulse device is higher than the average pressure value in the heat transferring volume by a predetermined difference upon impulse of the working medium into the heat transferring medium and lower than the predetermined difference between consecutive impulses of the working medium.

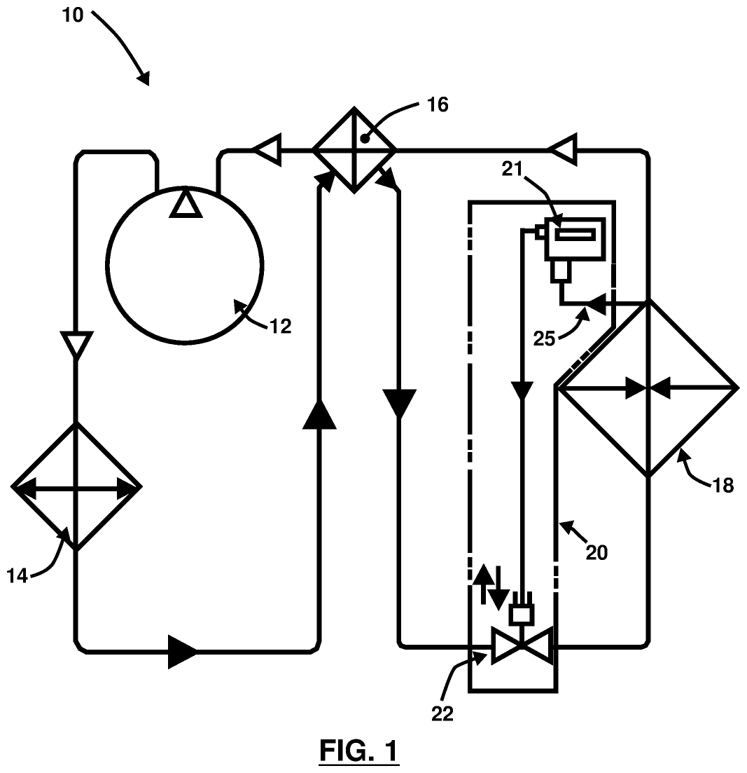

Referring to FIG. 1 a schematic diagram of a test system 10 based on the impulse method of supplying of a working medium in accordance with the present invention is depicted. This test system 10 may equate to a refrigerating system of an air conditioner.

The system 10 consists of a compressor 12, condenser 14, regenerating heat exchanger 16, evaporator 18, and impulse device 20. The impulse device 20 preferably includes a differential pressure relay 21 and solenoid valve 22, which is integrated into one housing or set-up separately, as indicated by the dashed lines.

The evaporator 18 has an inlet located at a bottom region thereof for receiving the working medium. The differential pressure relay 21 is an element of the impulse device 20 and is connected using an impulse pipe 25 that is connected to the upper (vapour) part of the evaporator 18 of heat receiving system. The evaporator 18 is a device constructed from metal alloys, for example, from aluminium-magnesium alloys.

In operating the test system 10, temperature measurements taken between the heat transfer wall and the surroundings were taken using a differential thermocouple battery. This battery consists of 50 copper-constant thermocouples, 150 mm long each and connected in series.

The value and direction of heat flows within the test system 10 were measured using highly sensitive sensors represented by copper-constant thermocouple batteries consisted of 2,000 thermocouples, 1.5 mm long and connected in series. Measurements of specific electrical resistance and electromotive force of the thermocouples were taken using a set-up consisting of potentiometers with 0.005 precision grade. Such measurements were made with 0.01 μV accuracy.

In operating the test system 10, it has been adopted by theory that the temperature of a solid body impacted by impulse heat flows is able to be determined by the following equation:

$$θ = \frac{ɛ}{4} {\int }^{{τ}^{★}} {e}^{( \frac{1}{2} {τ}^{★} )} \frac{( {l}_{1} ( \frac{1}{2} τ \cdot \sqrt{( 1 - \frac{{ɛ}^{2}}{{τ}^{{★}^{2}}} )} ) )}{( \frac{1}{2} {τ}^{★} \sqrt{( 1 - \frac{{ɛ}^{2}}{{τ}^{{★}^{2}}} )} )} \cdot d {τ}^{★} + {e}^{( \frac{1}{2} ɛ )} \qquad ( 4 )$$

Where—

θ,ε,τ*

are non-dimensional parameters

$$θ = \frac{T}{{T}_{0}} ; ɛ = \frac{x}{\sqrt{( a {τ}_{0} )}} ; {τ}^{★} = \frac{τ}{{τ}_{0}} ;$$

T₀—initial temperature of the body
τ—time
τ₀—initial instant of moment

$$τ = Δ \cdot \sqrt{( \frac{{τ}_{0}}{a} )}$$

a—speed of sound in medium

$$Δ = τ \cdot \sqrt{( \frac{a}{{τ}_{0}} )}$$

front of heat flow (or break point)

The test system 10 is operated using a compressor 12 to extract cool vapour from the evaporator 18. This cool vapour passes through the first chamber of regenerative heat exchanger 16 and is then pumped into the condenser 14. The cool vapour is then condensed into a liquid and fed back to the evaporator 18 through the second chamber of heat exchanger 16 and impulse device 20. The delivery of the liquid to the evaporator 18 is done by impulses. The range of the impulse device (20; 21; 22) exceeds the selected boiling pressure (and correspondingly the evaporating temperature in evaporator 18) at activation, for example, by ΔP₁=0.1÷0.4 bar, and at deactivation, is below the selected pressure by ΔP₂=0.1÷0.4 bar, whereas, the average pressure in the evaporator 18 will correspond to preliminary selected, based on technological parameters.

All long term experiments on models conducted in accordance with the present invention have confirmed the possibility of increasing heat transfer through a metal wall using an impulse method by 15%, when compared with traditional throttling methods. In the test system 10, the heat receiver (evaporator) 18 is made from aluminium-magnesium and stainless-steel alloys.

In the test system 10, the liquid working medium is supplied by impulses into an evaporator 18 under pressure, for example, equal to the pressure of the liquid in the condenser 14. This differs considerably from traditional cooling systems, where, prior to supply into an evaporator, the liquid working medium is throttled, and boils with decreased pressure absorbing the heat.

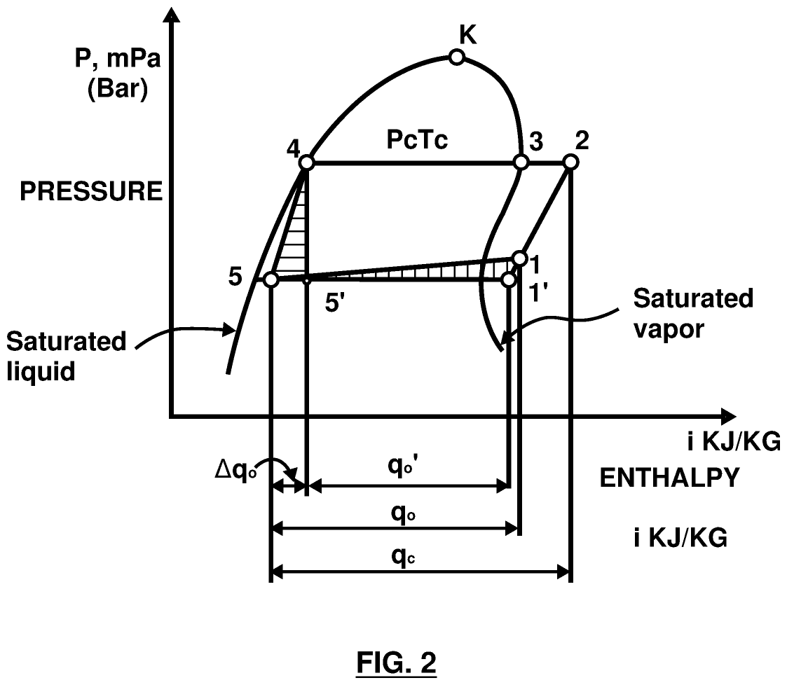

Referring to FIG. 2, this shows comparative theoretical cycles of a thermal system similar to system 10 (refrigerating system of an air conditioner) with the working medium being a refrigerant R134A which functions by the impulse method of the present invention as also with throttling, where:

Line 1-2—compression of vapour in a compressor 12;
Line 2-3-4—condensation of working medium in a condenser 14;
Line 4-5′—throttling (constant enthalpy), in a cycle with throttling;
Line 4-5—impulse supply of working medium in a heat receiver (evaporator) 18, in impulse cycle.

The closer the line 4-5 is to the boundary of saturation curve that curbs transition of vapour into liquid, the less presence there is of the vapour component in the evaporator 18 (assumed as 20% for calculations). Therefore, the closer the impulse device (21, 22) is, the less vapour from working liquid gets into the heat receiver (evaporator 18) during the supply. Thus, Points 1′-2-3-4-5′ mark the cycle with throttling of working medium (suggested by Carl Linde in 1870) and Points 1-2-3-4-5 mark the cycle with impulse method of supply of working medium to heat receiver in accordance with the present invention. It is established that in a process of throttling there is no effective expansion work produced by the working medium. Therefore, the energy spent for the work that can be done by the working medium in case of adiabatic expansion (for example, in an expansion machine) during throttling is absorbed by working medium in a form of heat and spent on additional vaporization. Therefore, it can be concluded that throttling increases the work in a cycle and reduces refrigeration capacity. In comparison, in the case of the impulse method of functioning of thermal equipment, the heat flow through a heat exchange wall increases as the work in the cycle decreases:

lw=l′w−Δlw, (5)

The refrigeration effect of thermal equipment increases;

qₒ=q′ₒ+Δqₒ (6)

Line 5′-1′—boiling in heat receiver (evaporator) during throttling.
Line 5-1—boiling in heat receiver (evaporator) with impulse supply.

Therefore, the refrigeration effect in a thermal equipment based on the impulse cycle is:

qₒ=i₁−i₅ (7)

Applied work is:

l=i₂−i₁ (8)

Thus the heat dissipated in the condenser 14 is:

q_{c}=i₂−i₄ (9)

The below table, Table 1, is a comparative calculation of efficiency of a refrigerating system, for example, an air conditioner, that uses throttling and non-throttling cycles. In making these calculations, no additional specific amendments for impulse impacts on heat exchange walls in heat receivers (air-coolers) were taken into consideration. Further, as part of this analysis, calculation procedures have been proposed that accommodate improvements of conditions for heat exchange through a solid wall, for example, made from metal alloys, with impulse impact methods.

An example of comparative calculation of throttling and non-throttling cycles of the refrigerating system of an air conditioner (see Table 1), where:
air temperature, ta=40° c.;
evaporating temperature, tₒ=+6° c.;
temperature of condensation, tc=+50° c.;
working medium—cooling agent R-134A;
Refrigeration Capacity—Q=100 Kw:

TABLE 1

| | Measured | | |
|---|---|---|---|
| No. | parameters | Throttling cycle | Non-throttling cycle |
| 1 | Parameters | | |
| | of node | | |
| | points: | | |
| | i_{1(+6C)}, kJ/kg | 410* | 410* |
| | i₂, kJ/kg | 440 | 440 |
| | i₄, kJ/kg | 271.6 | 259.4 |
| | i₅, kJ/kg | 271.6 | −208.1 |
| | i_{5′}, kJ/kg | — | |
| 2 | Specific | q′₀ = iᵢ − i₅ = = 410 − 271.6 = 138.4 | q₀ = (i₁ − i₅′) · k = (410 − 208.1) · 0.8 = 161.5, |
| | mass | | where k is amount of vapour in a liquid |
| | refrigeration | | working medium (~20%), k = 0.8 |
| | capacity, | | |
| | kJ/kg | | |
| 3 | Heat | q_{c} = i₂ − i₄ = = 440 − 271.6 = 168.4 | q_{c} = i₂ − i₄ = = 440 − 271.6 = 168.4 |
| | rejected in | | |
| | condenser, | | |
| | kJ/kg | | |
| 4 | Specific | l_{c} = i₂ − i₁ = = 440 − 410 = 30 | l_{c} = i₂ − i₁ = = 440 − 410 = 30 |
| | isentropic | | |
| | (adiabatic) | | |
| | work of | | |
| | compressor, | | |
| | kJ/kg | | |
| 5 | Theoretical refrigeration coefficient | $ξ = \frac{{q}_{0}}{{l}_{c}} = \frac{( {i}_{1} - {i}_{5} )}{( {i}_{2} - {i}_{1} )} == \frac{( 440 - 271.6 )}{( 440 - 410 )} = 416$ | $ξ = \frac{{q}_{0}}{{l}_{c}} = \frac{( ( {i}_{1} - {i}_{5}^{′} ) \cdot k )}{( {i}_{\underline{2}} - {i}_{1} )} == \frac{( ( 410 - 208.1 ) \cdot 0.8 )}{( 440 - 410 )} = 5.38$ |
| 6 | Mass flow rate of working | ${G}_{a} = \frac{{Q}_{0}}{{q}_{0}} = \frac{100}{138.4} = 0.72$ | ${G}_{a} = \frac{{Q}_{0}}{{q}_{0}} = \frac{100}{161.5} = 0.619$ |
| | medium, | | |
| | kg/s | | |
| 7 | Isentropic | Nₐ = Gₐ · l_{c} = = 0.72 · 30 = 21.7 | N′ₐ = Gₐ · l_{c} = = 0.619 · 30 = 18.57 |
| | (adiabatic) | | |
| | power of | | |
| | compressor, | | |
| | kW | | |
| 8 | Effective power, kW, where η₁ is a coefficient of | ${N}_{{l}_{1}} = \frac{{N}_{a}}{( {η}_{1} \cdot {η}_{2} \cdot {η}_{3} )} == \frac{21.7}{( 0 .85 \cdot 0.85 \cdot 0.93 )} = 32.3$ | ${N}_{{l}_{1}} = \frac{( {N}_{a}^{′} )}{( {η}_{1} \cdot {η}_{2} \cdot {η}_{3} )} == \frac{18.57}{( 0.85 \cdot 0.8 \; 5 \cdot 0.9 \; 3 )} = 27.6$ |
| | visible volumetric | | |
| | losses, η₁ = 0.85, | | |
| | heating | | |
| | coefficient, η₂ = | | |
| | 0.85 | | |
| | friction losses | | |
| | coefficient, η₃ = | | |
| | 0.93 | | |
| 9 | Power gain, Δξ = 17% | | $Δ N = {N}_{{l}_{1}} - {N}_{{l}_{2}} = 32.3 - 27.6 = 4.7$ $Δξ = \frac{( Δ N )}{{N}_{{l}_{2}}} \cdot 100 = \frac{4.7}{27.6} \cdot 100 = 17 \%$ |

*The value is taken to be the same for simplicity.

It will be appreciated that the present invention has determined that through the use of impulse and cyclic methods of impact of heat flows on a heat-transferring surface for transfer of heat through a wall made from metal alloys, increases in heat transfer efficiency of more than 15-20% are possible. Such an impulse method of heat transfer enables more effective use of heat exchange systems in newly designed thermal equipment and can significantly improve the efficiency of existing thermal equipment in the market.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

The invention can be described in terms of claims that can assist the skilled reader in understanding the various aspects and preferments of the invention. However, these claims are not to be construed as defining statements of the invention. It will be appreciated that other forms, aspects and preferred features of the invention and its embodiments described herein may ultimately be included in the claims defining the invention in the specifications of complete, international or national applications (or their subsequent corresponding patent grants) that may claim priority from the provisional application from which this application claims priority. In this context, the following non-limiting claims assist to better describe the invention.

1. An impulse heat exchange system comprising:
a heat transferring volume; and
an impulse device,
wherein said impulse device is in thermal, pressure and fluid communication with said heat transferring volume,
said impulse device is configured to receive a working medium in condensed phase and introduce said working medium into said heat transferring volume in an impulse regimen of heat flow.

2. The impulse heat exchange system according to claim 1, wherein said impulse device comprises a device for regulating supply of said working medium to said heat transferring volume in said impulse regimen of heat flow, wherein said impulse regimen of heat flow maintains non-equilibrium heat capacity of walls of said heat transferring volume.

3. The impulse heat exchange system according to claim 2, wherein said impulse regimen of heat flow comprises:
setting average pressure and corresponding boiling temperature values of said working medium in said heat transferring volume;
setting pressure value of said working medium in said impulse device at a predetermined difference from said average pressure in said heat transferring volume; and
introducing selected amounts of said working medium at selected frequency from said impulse device into said heat transferring volume,
wherein said selected amounts and frequency are set to maintain said nonequilibrium heat capacity of said walls of said heat transferring volume, said walls are maintained at thermal non-equilibrium state upon transfer of heat load from said working medium through said walls to surroundings of said walls.

4. The impulse heat exchange system according to claim 2, wherein said device for regulating supply of said working medium is configured to control frequency of impulses and increase said frequency upon incremental increase in said heat load and decrease said frequency upon incremental decrease in said heat load upon introduction of said working medium from said impulse device into said heat transfer volume.

5. The impulse heat exchange system according to claim 3, wherein said pressure value in said impulse device is higher than said average pressure value in said heat transferring volume by said predetermined difference upon impulse of said working medium into said heat transferring medium and lower than said predetermined difference between consecutive impulses of said working medium.

6. The impulse heat exchange system according to claim 5, wherein said predetermined difference between said pressure value of said working medium in said impulse device and said average pressure of said working medium in said heat transferring volume is 0.1÷0.4 bar.

7. The impulse heat exchange system according to claim 3, wherein said average pressure value is 0.1÷0.4 bar.

8. The impulse heat exchange system according to claim 3, wherein said frequency is set to impulse said working medium into said heat transferring volume before heat capacity of said walls returns to thermal equilibrium.

9. The impulse heat exchange system according to claim 2, wherein said non-equilibrium heat capacity of said walls is calculated according to the following equation:
$$d C v = d \frac{( \partial U )}{( \partial T )} + d ( \frac{( \partial C v )}{( \partial T )} x \frac{( \partial T )}{( \partial τ )} ) .$$

10. The impulse heat exchange system according to claim 9, wherein temperature of said walls is maintained above or below said thermal equilibrium of said walls with said surroundings.

11. The impulse heat exchange system according to claim 10, wherein said temperature is determined according to the following equation:
$$θ = \frac{ɛ}{4} {\int }^{{τ}^{★}} {e}^{( \frac{1}{2} {τ}^{★} )} \frac{( {l}_{1} ( \frac{1}{2} τ \cdot \sqrt{( 1 - \frac{{ɛ}^{2}}{{τ}^{{★}^{2}}} )} ) )}{( \frac{1}{2} {τ}^{★} \sqrt{( 1 - \frac{{ɛ}^{2}}{{τ}^{{★}^{2}}} )} )} \cdot d {τ}^{★} + {e}^{( \frac{1}{2} ɛ )} .$$

12. The impulse heat exchange system according to claim 3, wherein said walls are made from metal or metal alloys.

13. The impulse heat exchange system according to claim 11, wherein said metal or metal alloys are aluminium-magnesium or stainless steel.

14. The impulse heat exchange system according to claim 2, wherein said working agent is a refrigerant.

15. The impulse heat exchange system according to claim 2, wherein said is refrigerant is R134A.

16. The impulse heat exchange system according to claim 2, wherein said heat transferring volume is an evaporator, said system further comprising:
a compressor;
a condenser; and
a regenerating heat exchanger,
wherein said impulse device is in thermal, pressure and fluid communication with said condenser through said regenerating heat exchanger and with said evaporator, said impulse device is configured to receive a working medium in condensed phase from said condenser through said regenerating heat exchanger and introduce said working medium into said evaporator in said impulse regimen of heat flow.

17. The impulse heat exchange system according to claim 16, wherein said impulse device comprises a differential pressure relay, a solenoid valve and an impulse pipe, said impulse pipe is connected to outlet of said evaporator.

18. The impulse heat exchange system according to claim 16, wherein said impulse device is integrated into housing of said system.

19. The impulse heat exchange system according to claim 16, wherein said impulse device is set-up separately from housing of said system.

20. The impulse heat exchange system according to claim 16, wherein said impulse device is located in close proximity to said evaporator.

21. A method for impulse heat exchange comprising:
providing a heat transferring volume and an impulse device in thermal, pressure and fluid communication with said heat transferring volume;
setting average pressure and corresponding boiling temperature values of working medium in said heat transferring volume;
setting pressure value of said working medium in said impulse device at a predetermined difference from said average pressure in said heat transferring volume; and
introducing selected amounts of said working medium in condensed phase at selected frequency from said impulse device into said heat transferring volume in an impulse regimen of heat flow; and
maintaining non-equilibrium heat capacity of walls of said heat transferring volume upon transfer of heat load from said working medium through said walls to surroundings of said walls.

22. The method according to claim 21, further comprising providing a device for regulating supply of said working medium in said impulse device;
controlling frequency of impulses and increasing said frequency upon incremental increase in said heat load and decreasing said frequency upon incremental decrease in said heat load upon introduction of said working medium from said impulse device into said heat transfer volume.

23. The method according to claim 21, wherein said pressure value in said impulse device is higher than said average pressure value in said heat transferring volume by said predetermined difference upon impulse of said working medium into said heat transferring medium and lower than said predetermined difference between consecutive impulses of said working medium.

24. The method according to claim 23, wherein said predetermined difference between said pressure value of said working medium in said impulse device and said average pressure of said working medium in said heat transferring volume is 0.1÷0.4 bar.

25. The method according to claim 21, wherein said average pressure value is 0.1÷0.4 bar.

26. The method according to claim 21, wherein said frequency is set to impulse said working medium into said heat transferring volume before heat capacity of said walls returns to thermal equilibrium.

27. The method according to claim 21, wherein said non-equilibrium heat capacity of said walls is calculated according to the following equation:
$$d C v = d \frac{( \partial U )}{( \partial T )} + d ( \frac{( \partial C v )}{( \partial T )} x \frac{( \partial T )}{( \partial τ )} ) .$$

28. The method according to claim 21, wherein temperature of said walls is maintained above or below thermal equilibrium of said walls with said surroundings.

29. The method according to claim 28, wherein said temperature is determined according to the following equation:
$$θ = \frac{ɛ}{4} {\int }^{{τ}^{★}} {e}^{( \frac{1}{2} {τ}^{★} )} \frac{( {l}_{1} ( \frac{1}{2} τ \cdot \sqrt{( 1 - \frac{{ɛ}^{2}}{{τ}^{{★}^{2}}} )} ) )}{( \frac{1}{2} {τ}^{★} \sqrt{( 1 - \frac{{ɛ}^{2}}{{τ}^{{★}^{2}}} )} )} \cdot d {τ}^{★} + {e}^{( \frac{1}{2} ɛ )} .$$

30. The method according to claim 21, wherein said walls are made from metal or metal alloys.

31. The method according to claim 30, wherein said metal or metal alloys are aluminium-magnesium or stainless steel.

32. The method according to claim 21, wherein said working agent is a refrigerant.

33. The method according to claim 32, wherein said refrigerant is R134A.

34. The method according to claim 21, wherein said heat transferring volume is an evaporator, said system further comprising:
a compressor;
a condenser; and
a regenerating heat exchanger,
wherein said impulse device is in thermal, pressure and fluid communication with said condenser through said regenerating heat exchanger and with said evaporator, said impulse device is configured to receive a working medium in condensed phase from said condenser through said regenerating heat exchanger and introduce said working medium into said evaporator in said impulse regimen of heat flow.

35. The method according to claim 34, wherein said impulse device comprises a differential pressure relay, a solenoid valve and an impulse pipe, said impulse pipe is connected to upper part of said evaporator.

36. The method according to claim 35, wherein said impulse device is integrated into housing of said system.

37. The method according to claim 34, wherein said impulse device is set-up separately from housing of said system.

38. The method according to claim 34, wherein said impulse device is located in close proximity to said evaporator.
